(19) United States
(12) Patent Application Publication
(10) Pub. No.: US 2021/0383342 A1
(43) Pub. Date: Dec. 9, 2021

(54) SYSTEM AND METHOD FOR WIRELESSLY RECEIVING AND PROCESSING A FIXED SUM

(71) Applicant: TIPTAPPAY MICROPAYMENTS LIMITED, Burlington (CA)

(72) Inventor: Christopher Andrew Greenfield, Burlington (CA)

(21) Appl. No.: 17/286,336

(22) PCT Filed: Oct. 18, 2019
(86) PCT No.: PCT/CA2019/051486

§ 371 Date: Apr. 16, 2021

(30) Foreign Application Priority Data
Oct. 19, 2018 (CA) 3021442

(51) Int. Cl. G06Q 20/20; G06Q 20/38

(52) U.S. Cl. CPC G06Q 20/202; G06Q 20/389

(57) ABSTRACT

The present disclosure provides a system and method for wirelessly receiving and sending a fixed sum. The method is comprised of receiving a fixed sum payment via an apparatus, sending information, including various identification to a server to be verified, and having the server then transmit payment information to an acquiring processor. Upon receipt of the necessary acknowledgment or verification, the server sends a signal to the apparatus to deny or approve the transaction. The system is comprised of an apparatus and a server, the apparatus configured to receive only a singular, fixed sum amount. When a command to process said singular fixed sum amount is received, the apparatus communicates with a server to verify the transaction, and the server communicates with an acquiring processor to process and approve the transaction. The server is configured to send a confirmation to the apparatus to approve or deny the transaction.

### FIELD

The invention relates to the field of point of sales systems, and more specifically to a point of sales system capable of wirelessly receiving and processing only a fixed monetary sum.

### BACKGROUND

In an increasingly digital world, point of sales (POS) systems have become ubiquitous with the modern business. Companies like Shopify™ or Square™ provide platforms, software or peripherals to assist businesses in accepting monies. Indeed, these businesses can provide peripherals to accept cash or wireless money through a card, cellular device, etc.

Unfortunately, the wide adoption of digital payments has caused a massive decline in small cash transactions, rendering them nearly obsolete. The increasing unavailability of cash is causing friction between merchants and consumers and creating barriers between people and the causes they care about.

As such, there is a need for a system and method that can provide smaller but fixed amounts through a secure network with a secure verification process and transaction process.

### SUMMARY

In an aspect, the present disclosure provides a method for receiving and processing a fixed sum, the method comprising: wirelessly receiving the fixed sum using an apparatus, the apparatus having a ledger containing ledger information and the apparatus configured to process a singular fixed sum amount; securely transmitting the ledger information to a server for processing; and, securely sending a result command to the apparatus, wherein the apparatus emits a signal based on the result command.

In another aspect, the present disclosure provides a system for wirelessly receiving and processing a fixed sum, the system comprising: an apparatus to wirelessly receive the fixed sum from a payment device, the apparatus having a signal acceptance emulator and a ledger containing ledger information, the apparatus configured to process a singular fixed sum amount; a server to receive the ledger information of the apparatus, the server further comprised of a matching ledger, wherein the server matches the ledger information to the matching ledger to provide additional security to the system, and wherein the server sends a result command to the apparatus.

### BRIEF DESCRIPTION OF THE DRAWINGS

The following figures serve to illustrate various embodiments of features of the disclosure. These figures are illustrative and are not intended to be limiting.

FIG. 1 is a perspective view of an apparatus for wirelessly receiving and processing a fixed sum, in accordance with an embodiment of the present disclosure;

FIG. 2 is a flow chart showing a typical transaction of the apparatus 10 in a Bluetooth™ enabled application;

FIG. 3 is a flow chart showing a typical transaction of the apparatus 10 in a Bluetooth™ Mesh enabled application;

FIG. 4 is a flow chart showing a typical transaction of the apparatus 10 in an LTE-M-enabled application;

FIG. 5 is a flow chart showing a typical transaction of the apparatus 10 in for a Bluetooth™ Store & Forward application; and,

FIG. 6 is a flow chart showing a verification method and transaction method of the system, in accordance with an embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

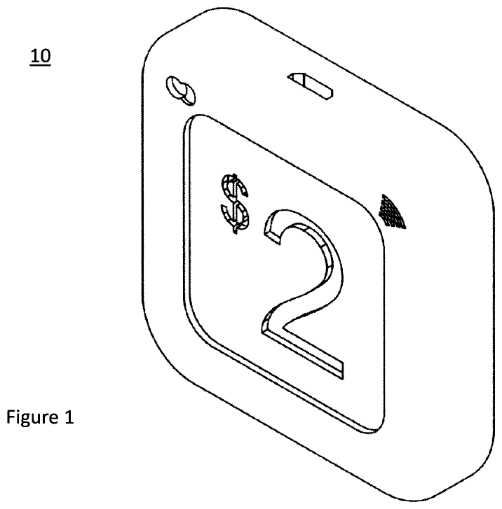

With reference to FIG. 1 and according to an embodiment of the present disclosure, an apparatus for wirelessly receiving and processing a fixed sum 10 is shown. The apparatus 10 is further comprised of a receiver, the receiver to wirelessly receive the fixed sum from the apparatus 10, and a transfer device to receive the payment from the receiver and wirelessly transmit the fixed sum to a server. The apparatus is pre-programmed to only accept a single, fixed sum; for example, $2 or $5 from a customer. Once the apparatus 10 is pre-programmed with the fixed sum, it cannot be changed. The apparatus 10 has a unique identifier to associate the fixed sum with the unique identifier. To make a payment, a near-field communication (NFC) card or other similar device sends a payment token associated with a unique customer number to the receiver, which is in communication with the transfer device. The transfer device then transmits the payment token along with the unique identifier and customer number to a server for processing by a bank. A worker skilled in the art would appreciate that a transfer device could include a LTEm modem. A blockchain ledger is utilized to securely associate and connect the unique identifier of the apparatus 10 with the fixed sum and a unique customer number. It is an advantage of the apparatus 10 that it can only accept a single, fixed sum of money to quickly and easily accept wireless payments from customers. Using a fixed sum amount is directly tied to the card reader device identity, thus adding an additional layer of security. Having a built-in modem such as the LTEm modem also facilitates payments and eliminates the need for external hardware. Indeed, the apparatus 10 does not require any external hardware, such as a computer, to input payment amounts and process the transaction.

With further reference to FIG. 1 and according to an embodiment of the present disclosure, the apparatus 10 has a close proximity (under 2.5 cm) nearest field antenna that reads only encrypted card payment information with a near physical tap to prevent accidental taps. If the apparatus 10 is tampered with in any way or if anyone attempts to alter the apparatus 10, it may immediately power off and erase the chip. The apparatus 10 preferably has 8 levels of tamper proof security from a fixed firmware (no updates by USB-c or remotely), pre-programed/fixed data ledger, on a secure chip, with multiple tamper points, filled with a tamper proof bonding agent that also provides thermal and water resistance attributes. The fixed amount (e.g. $2, $5, $10, etc) is pre-programed on the apparatus 10 and is permanently embedded so that it cannot ever be changed. In addition to the fixed amount, the apparatus 10 is also pre-programmed with a unique customer number and device number. The apparatus 10 is a data transmission device and preferably has no on-board storage besides the kernel firmware and ledger verification numbers. The apparatus 10 is also preferably affixed to collateral with a secure gasket that locks the apparatus 10 in place from both sides. If the apparatus 10 is removed, a tamper button may be released that disables the apparatus 10 and sends a tamper notification to the apparatus 10 server. An administrator can then reactivate the apparatus 10 if this was intentional, whereas if it was not intentional the apparatus 10 may remain inactive and respond only to requests for a GPS ping to indicate its current location.

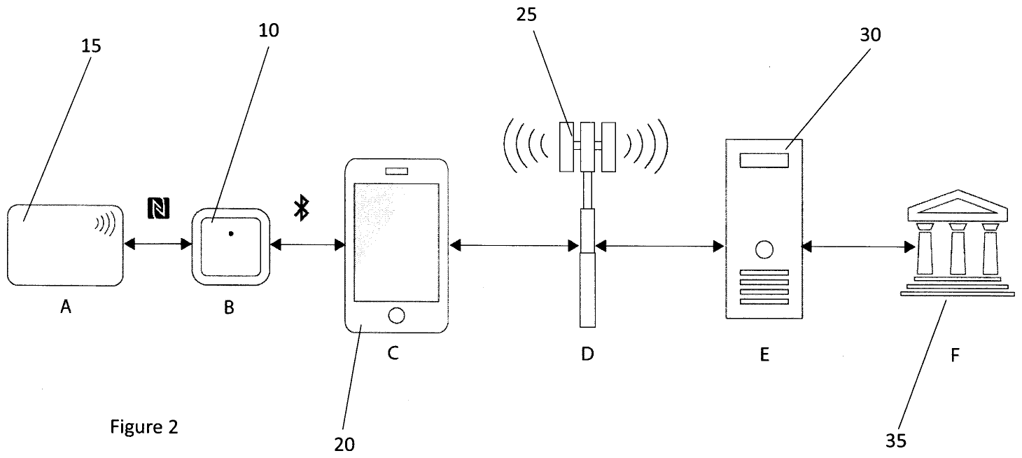

With reference to FIG. 2 and according to an embodiment of the present disclosure, a flow chart is shown describing a typical transaction of the apparatus 10 in a Bluetooth™ enabled application. First a payment device 15 such as a card, FOB, or smartphone in card emulation mode, is recognized by the apparatus 10. Then, the apparatus 10 selects a payment application on the payment device 15. The apparatus 10 issues a one-time cryptographic challenge to the payment device 15. The challenge includes transaction information such as the payment amount and a unique identifier for the apparatus 10. The payment device 15 signs the challenge using a private key securely stored on the payment device 15 and transmits the cryptogram to the apparatus 10. The apparatus 10 verifies the authenticity of the payment device 15 using the cryptogram and the public key of the payment device 15. The cryptogram and token provided by the payment device 15 is then forwarded by the apparatus 10 for verification on a payment network. For the presently-described Bluetooth™ only solution, this involves initial transmission to a smartphone device 20. The smartphone device 20 then forwards the transaction using a network connection 25 such as Wi-Fi or GSM. The transaction is sent to an acquirer 30 that contacts the issuer 35, for approval or denial of the transaction. A worker skilled in the art would appreciate that the issuer 35 is typically bank or other financial institution. The transaction response is sent back to the smartphone device 20 and then on to the apparatus 10, which signals the response using a visual LED and/or audio tone.

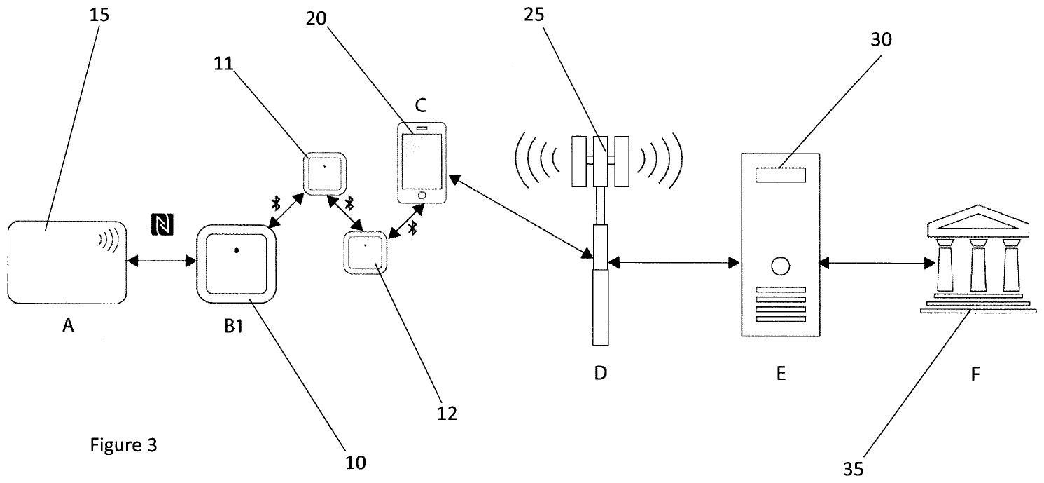

With reference to FIG. 3 and according to an embodiment of the present disclosure, a flow chart is shown describing a typical transaction of the apparatus 10 in a Bluetooth™ Mesh enabled application. First, the payment device 15 such as a card, FOB, or smartphone in card emulation mode, is recognized by the apparatus 10. The apparatus 10 selects a payment application on the payment device 15. The apparatus 10 then issues a one-time cryptographic challenge to the payment device 15. The challenge includes transaction information such as the payment amount and a unique identifier for the apparatus 10. The payment device 15 signs the challenge using a private key securely stored on the payment device 15 and transmits the cryptogram to the apparatus 10. The apparatus 10 verifies the authenticity of the payment device 15 using the cryptogram and the public key of the payment device 15. The cryptogram and token provided by the payment device 15 is forwarded by the apparatus 10 for verification on a payment network. For this embodiment, a mesh of Bluetooth™-enabled apparatuses 10, 11, 12 can be used, with each apparatus 10, 11, 12 acting as a stepping stone. The mesh devices can be additional card readers, or they could be Bluetooth™-enabled devices such as smartphones or computers. The progression of connections may not necessarily be immediate. The transaction is sent by means of a network connection 25 to a server 30, which then sends the request to the processor who in turn contacts the issuing bank 35 before sending back an approval or denial of the transaction. In this embodiment, the path from the apparatus 10 to the acquirer 30 may no longer be available by the time the transaction is processed; therefore, a response may not be provided to the initial apparatus 10.

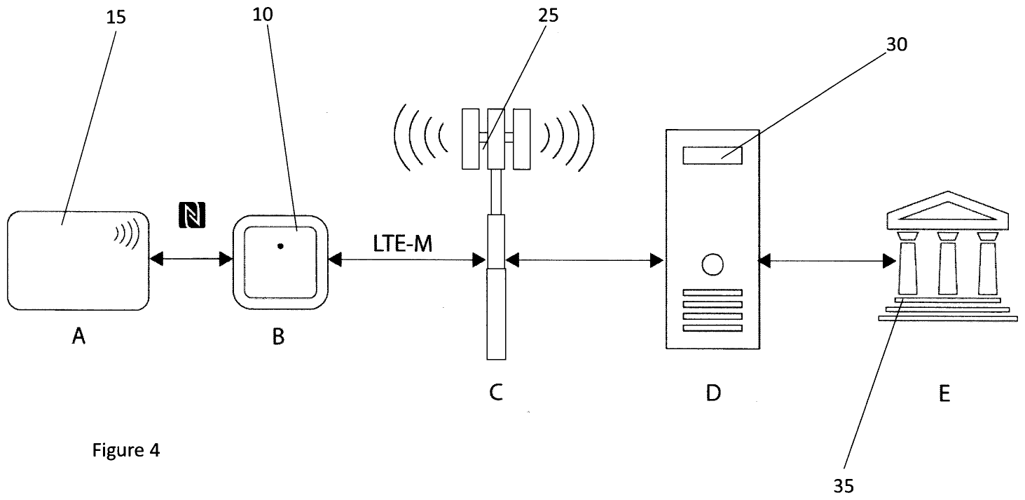

With reference to FIG. 4 and according to an embodiment of the present disclosure, a flow chart is shown describing a typical transaction of the apparatus 10 in a LTE-M-enabled application. First, a payment device 15 such as a card, FOB, or smartphone in card emulation mode, is recognized by the apparatus 10. The apparatus 10 then selects a payment application on the payment device 15. The apparatus 10 issues a one-time cryptographic challenge to the payment device 15. The challenge includes transaction information such as the payment amount and a unique identifier for the apparatus 10. The payment device 15 signs the challenge using a private key securely stored on the payment device 15 and transmits the cryptogram to the apparatus 10. The apparatus 10 then verifies the authenticity of the payment device 15 using the cryptogram and the public key of the payment device 15. The cryptogram and token provided by the payment device 15 is forwarded by the apparatus 10 for verification on a payment network. For this cellular LTE-M only embodiment, the apparatus 10 connects directly with a cellular network 25. The transaction is sent to an acquirer 30, which contacts the issuer 35 for approval or denial of the transaction. The transaction response is sent back to the apparatus 10, which signals the response using a visual LED and/or audio tone.

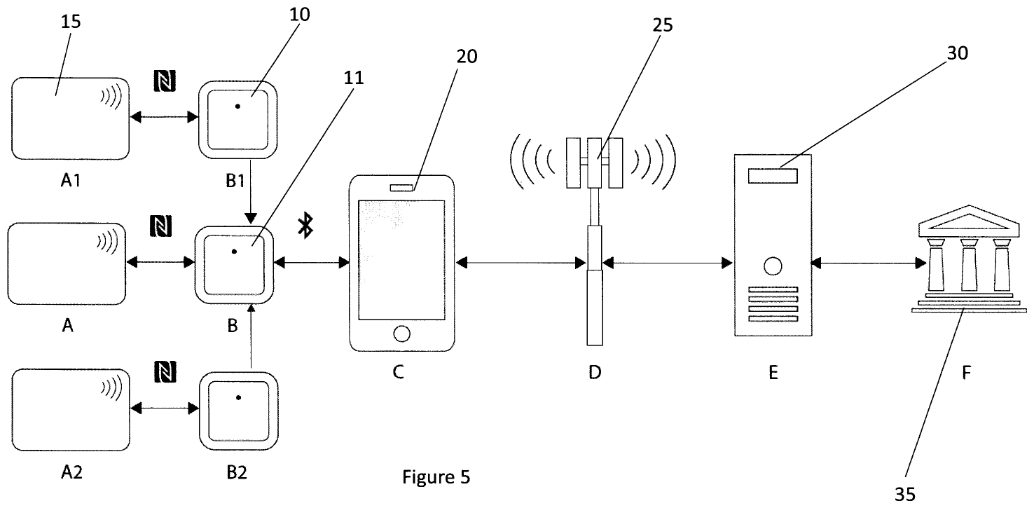

With reference to FIG. 5 and according to an embodiment of the present disclosure, a flow chart is shown describing a typical transaction of the apparatus 10 in for a Bluetooth™ Store & Forward application. First, a payment device 15 such as a card, FOB, or smartphone in card emulation mode, is recognized by the apparatus 10. The apparatus 10 selects a payment application on the payment device 15. The apparatus 10 issues a one-time cryptographic challenge to the payment device 15. The challenge includes transaction information such as the payment amount and a unique identifier for the apparatus 10. The payment device 15 then signs the challenge using a private key securely stored on the payment device 15 and transmits the cryptogram to the apparatus 10. The apparatus 10 verifies the authenticity of the payment device 15 using the cryptogram and the public key of the payment device 15. The cryptogram and token provided by the payment device 15 is stored on the apparatus 10 for processing at a later time. The apparatus 10 may connect to a smartphone 20 or directly to a cellular network 25 at a later time, or it may transfer the transaction data to another apparatus 11 for further processing. The transaction response is sent back only to the smartphone 20 that initiated the accumulated transaction data.

A worker skilled in the art would appreciate that the apparatus 10 may be fitted with a GPS location device. The use of such a built-in GPS is an aid to counter fraud and has not been seen in POS systems to date. Further, the fixed sum transactions can be transferred in a peer-to-peer manner; from apparatus 10 to another apparatus 11, for example, which has never been seen in a POS system. Another novel aspect is that the apparatus 10 is small and required no hardwired connections, and therefore is wearable. Further, although it is preferred that the apparatus 10 have a touch screen interface, the apparatus 10 can be commanded using physical gestures such as tapping or shaking. These gestures are translated into commands using an onboard accelerometer and gyroscope. The Bluetooth™ connectivity of the apparatus 10 means that multiple units can be programmed simultaneously. Currently, POS devices are programmed one-by-one. Finally, each apparatus 10 carries a QR code than contains a Uniform Resource Identifier (URI) containing serial number information that directs to an online authentication server. By scanning the QR code, a customer can verify the authenticity of the apparatus 10, which adds more security.

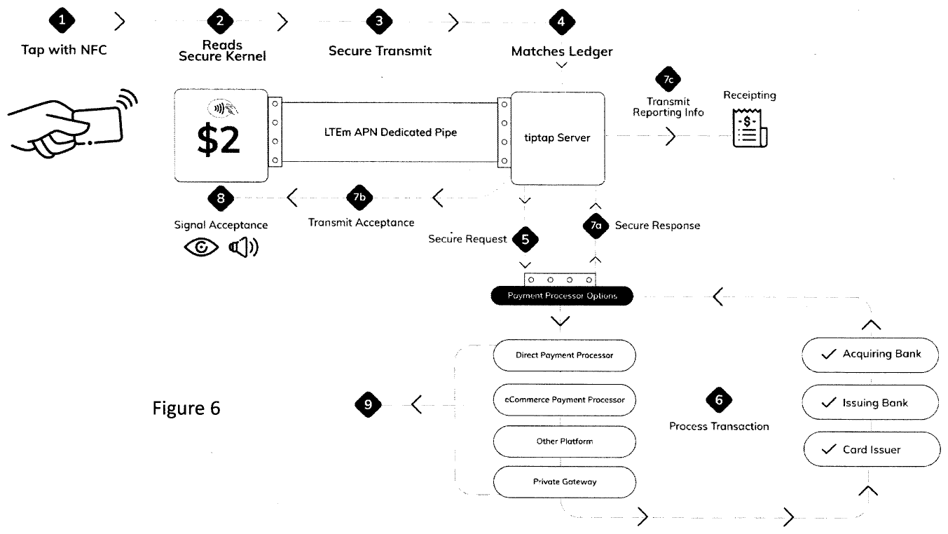

With reference to FIG. 6 and according to an embodiment of the present disclosure, the transaction method 100 is shown in greater detail. In step 1, a user uses their preferred payment device, preferably having NFC capabilities near the apparatus 10. In step 2, the apparatus 10 uses its secure kernel to communicate with the user's preferred payment device, and then references the ledger information prior to completing the transaction. As previously outlined, the apparatus 10 has a pre-programmed denomination amount, device number and customer number, which together form part of the ledger. In step 3, the ledger information (i.e. the customer number, device number and denomination amount) along with GPS location and encrypted payment information are transmitted to a pre-determined processing server 110. Such information is preferably transmitted by means of a soldered SIM with the secure and direct connectivity of a dedicated custom APN pipe on an LTE network with site-to-site VPN. In step 4, once the server 110 has received the information, it matches the received ledger to a server ledger. This verification process is done to ensure that the apparatus 10 is legitimate and not fraudulent. If there are any discrepancies between these ledgers, the server 110 sends a signal to the apparatus 10 that the transaction was declined. In step 5, if the ledgers match, the server 110 sends a secure request (which includes payment information) to the processor of choice. In step 6, the transaction is processed. This may be from a direct payment processor or e-commerce processor, another platform or even an existing private gateway. The acquiring processor then verifies the transaction. In step 7a, the acquiring processor determines whether the transaction is approved or declined. In either instance, a message is sent back to the server 110, which transmits the acceptance or denial to the apparatus 10 in step 7b. In step 7c, the server 100 also transmits such transactional information to a reporting application 120. Such transactional information may include for example the time and date of transaction, the amount paid, the financial institution used, the payment device, etc. In step 8, the apparatus 10 sends a visual and/or audio signal to denote transaction approval (or denial). In a separate step 9, the acquiring processor will settle the amount directly with the institution receiving the funds.

With further reference to FIG. 6 and for greater clarity, a worker skilled in the art would appreciate that there are two methods that exist. The first is the verification process, whereby the server 110 matches ledger information to verify that the apparatus 10 is in fact correct and sending the correct information based on pre-determined and pre-configured parameters. The second is the transactional process, whereby the system described processes a fixed sum transaction using both the apparatus 10 and the server 110. The only verification that occurs in this second transactional process is by the acquiring processor, which transmits an acceptance or refusal of the transaction to the server 100, which itself sends a corresponding accept or decline signal to the apparatus 10 to notify a user the status of the payment transaction.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A method for receiving and processing a fixed sum, the method comprising:
wirelessly receiving the fixed sum using an apparatus, the apparatus having a ledger containing ledger information and the apparatus configured to process a singular fixed sum amount;
securely transmitting the ledger information to a server for processing; and,
securely sending a result command to the apparatus, wherein the apparatus emits a signal based on the result command.

2. The method of claim 1 wherein the ledger information is further comprised of the singular fixed sum amount, a customer number and a device number.

3. The method of claim 1 wherein the server transmits reporting information to a reporting application.

4. The method of claim 1 wherein the processing step is further comprised of matching the ledger information with a server ledger to generate a match analysis, the match analysis being one of:
a positive match; and,
a negative match.

5. The method of claim 4 wherein if the server generates the negative match, the result command is for the apparatus to refuse the fixed sum.

6. The method of claim 1 further comprised of the steps:
sending a request from the server to an acquiring processor to be validated; and,
receiving a response from the acquiring processor, the response being one of:
a positive response; and,
a negative response.

7. The method of claim 6 wherein if the response is the negative response, the result command is for the apparatus to refuse the fixed sum.

8. The method of claim 6 wherein if the response is the positive response, the result command is for the apparatus to accept the fixed sum.

9. A system for wirelessly receiving and processing a fixed sum, the system comprising:
an apparatus to wirelessly receive the fixed sum from a payment device, the apparatus having a signal acceptance emulator and a ledger containing ledger information, the apparatus configured to process a singular fixed sum amount;
a server to receive the ledger information of the apparatus, the server further comprised of a matching ledger,
wherein the server matches the ledger information to the matching ledger to provide additional security to the system,
and wherein the server sends a result command to the apparatus.

10. The system of claim 9 wherein the server is configured to communicate with an acquiring processor to process the fixed sum.

11. The system of claim 9 wherein transactional information is transmitted from the server to a reporting application.

12. The system of claim 9 wherein the apparatus emits a signal based on the result command.

13. The system of claim 9 wherein the ledger information is further comprised of the singular fixed sum amount, a customer number and a device number.
